(19) United States
(12) Patent Application Publication
(10) Pub. No.: US 2024/0392447 A1
(43) Pub. Date: Nov. 28, 2024

(54) WATER ELECTROLYSIS USING SALINE WATER

(71) Applicant: HYDROLITE LTD, Caesarea (IL)

(72) Inventors: Miles PAGE, Hod Hasharon (IL); Alina AMEL, Binyamina (IL); Mordechai KATTAN, Harish (IL)

(73) Assignee: HYDROLITE LTD, Caesarea (IL)

(21) Appl. No.: 18/685,608

(22) PCT Filed: Jul. 26, 2022
(86) PCT No.: PCT/IL2022/050805

§ 371 Date: Feb. 22, 2024

Related U.S. Application Data
(60) Provisional application No. 63/236,698, filed on Aug. 25, 2021.

(51) Int. Cl. C25B 1/04; C25B 9/23; C25B 15/08

(52) U.S. Cl. CPC C25B 1/04; C25B 9/23; C25B 15/087

(57) ABSTRACT

Water electrolyzers, systems and methods are provided, which operate with saline water to produce hydrogen. Water electrolyzers comprise an electrode assembly configured to electrolyze received water to produce oxygen and hydrogen, and one or more diffusion layer(s) attached to one of the electrodes of the electrode assembly and configured to deliver the water for the electrolysis by excluding specified ions from received saline water. Excluding anions such as chloride ions and optionally cations from the received saline water enable maintaining the operation and efficiency of the water electrolyzers in spite of using un-deionized water for electrolysis. Ion exchange column(s) may be used to retain and/or regenerate the alkalinity (or possibly the acidity) in the electrolyzer if needed and to remove anions and optionally cations.

### BACKGROUND OF THE INVENTION

### 1. Technical Field

The present invention relates to the field of water electrolysis, and more particularly, to hydrogen production using saline water.

### 2. Discussion of Related Art

Water electrolyzers generate hydrogen from an input of electrical energy at an appropriate potential to a reservoir of water. The water is split by that energy input into H₂ and O₂ according to: 2H₂O>2H₂+O₂. The electrolysis concept involves separating this reaction into Oxidation and Reduction half-reactions, normally carried out in separate compartments that are operatively connected via an ion-conductive “separator” that allows the exchange of the ionic species, and by an electrical circuit that transfers electrons, between the electrodes. The oxidation half-reaction is the so-called Oxygen Evolution Reaction (OER), and the reduction half-reaction is the Hydrogen Evolution Reaction (HER). These half reactions can be represented as follows (i) 2H₂O>O₂+4H⁺+4e⁻ (OER); and (ii) 2H⁺+2e⁻>H₂ (HER). In alkaline environments, these half reactions can be represented by equivalent reactions: (i) 4OH⁻>O₂+2H₂O+4e⁻ (OER); and (ii) 2H₂O+2e⁻>H₂+2OH⁻ (HER).

Increasingly, Water Electrolysis (WE) is desirable as a means to generate “Green Hydrogen”, namely hydrogen produced without significant CO₂ emissions, which is the case if the input electricity is renewably sourced-hydrogen so-generated then being a means to sustainably store electrical energy for later conversion back to electricity in a hydrogen fuel cell, or for use in a multitude of other processes for which hydrogen can be a key process input.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a water electrolyzer comprising: an electrode assembly configured to electrolyze received water to produce oxygen and hydrogen, the electrode assembly comprising two electrodes that are separated by a separator and receive electrical input to carry out the electrolysis, and at least one diffusion layer attached to one of the electrodes and configured to deliver the water for the electrolysis by excluding specified ions from received saline water from a saline water source.

One aspect of the present invention provides a water electrolyzer system comprising the disclosed water electrolyzers, a power source connected to and operating the water electrolyzer, and an electrolyte circulation unit configured to remove oxygen from and recycle the electrolyte.

One aspect of the present invention provides a method comprising excluding specified ions from received saline water to operate a water electrolyzer therewith, wherein the ions are removed by at least one diffusion layer attached to one of the electrodes of the water electrolyzer.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIGS. 1A and 1B are high-level schematic illustrations of water electrolyzers with diffusion layer(s) and saline water supply, according to some embodiments of the invention.

FIGS. 1C and 1D are high-level schematic illustrations of diffusion layer(s), according to some embodiments of the invention.

FIG. 2 is a high-level schematic illustration of a water electrolyzer system, according to some embodiments of the invention.

FIG. 3 is a high-level schematic illustration of prior art water electrolyzers and systems.

FIG. 4 is a high-level flowchart illustrating a method, according to some embodiments of the invention.

FIGS. 5A-5D present initial experimental results that indicate the effective operation of water electrolyzers with diffusion layer(s), according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for generating hydrogen using saline water and thereby provide improvements to the technological field of water electrolyzers.

Water electrolyzers, systems and methods are provided, which operate with saline water to produce hydrogen. Water electrolyzers comprise an electrode assembly configured to electrolyze received water to produce oxygen and hydrogen, and one or more diffusion layer(s) attached to one of the electrodes of the electrode assembly and configured to deliver the water for the electrolysis by excluding specified ions from received saline water. Excluding anions such as chloride ions and optionally cations from the received saline water enable maintaining the operation and efficiency of the water electrolyzers in spite of using un-deionized water for electrolysis. Ion exchange column(s) may be used to retain and/or regenerate the alkalinity (or possibly the acidity) in the electrolyzer if needed and to remove anions and optionally cations.

Specifically, disclosed water electrolyzers, systems and methods not only produce hydrogen, which is considered an efficient low contaminating fuel, but also operate with saline water which are typically not directly usable-enhancing the environmental friendliness of embodiments of the disclosed invention.

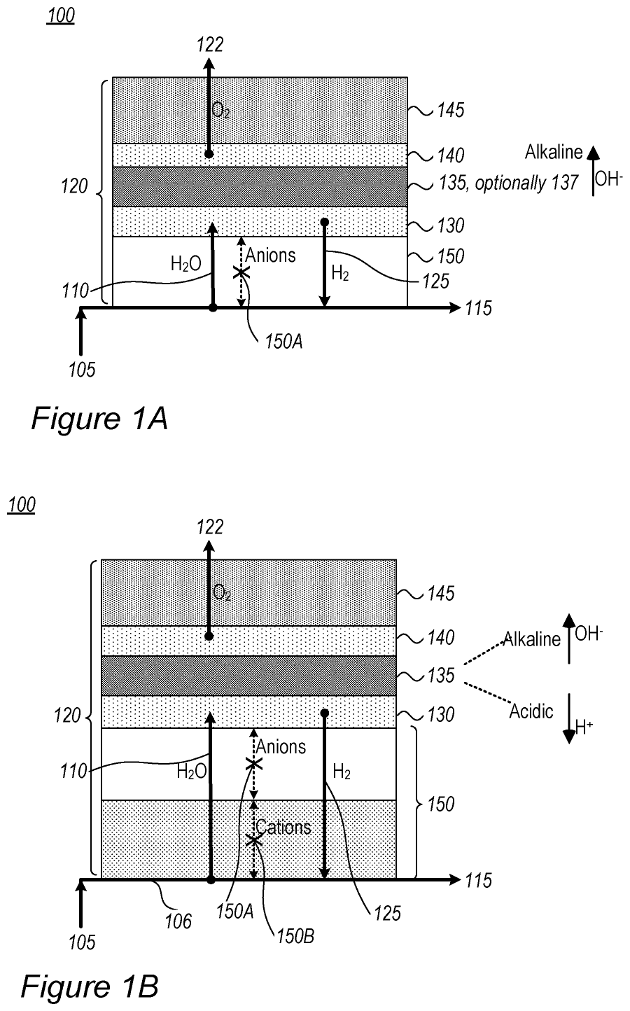

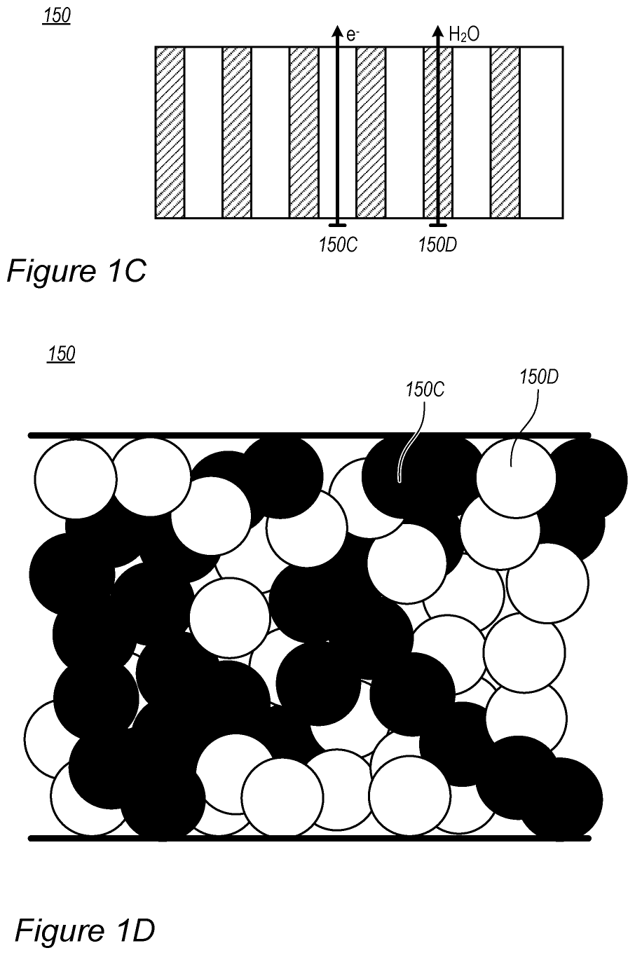

FIGS. 1A and 1B are high-level schematic illustrations of water electrolyzers 100 with diffusion layer(s) 150 and saline water supply 105, according to some embodiments of the invention. Water electrolyzers 100 may comprise an electrode assembly 120 configured to electrolyze received water 110 to produce oxygen 122 and hydrogen 125. Electrode assembly 120 may comprise two electrodes 130, 140 (e.g., cathode and anode respectively) that are separated by a separator 135 and receive electrical input to carry out the electrolysis. One or both electrodes 130, 140 may comprise respective catalysts that catalyze the electrolysis reaction. Diffusion layer(s) 150 may be attached to one of electrodes 130, 140 and be configured to deliver water 110 for the electrolysis by excluding specified ions (150A and or 150B) from received saline water 106 from a saline water source 105. In the illustrated non-limiting example, diffusion layer(s) 150 is illustrated to be attached to cathode 130, with anode diffusion media 145 supporting anode 140 mechanically and enabling removal of generated oxygen. In disclosed embodiments, low-salinity water 110 is removed from received saline water 106 for the electrolysis, removing saline water 115 from electrolyzer 100. Saline water supply 105 may comprise any source of saline or brackish water, having any degree and composition of dissolved salts. Water from saline water supply 105 may be filtered before delivery to water electrolyzer 100, e.g., to remove particles and/or foulants.

In certain embodiments, electrode assembly 120 may be configured as alkaline electrolyzer to comprise alkaline electrolyte 137 (passing hydroxides from cathode 130 to anode 140, e.g., KOH at 5-10M, and optionally held within porous solid matrix 135) and diffusion layer(s) 150 is configured to reject at least anions of the saline water. Alternatively, electrode assembly 120 may be configured as AEM (anion exchange membrane) electrolyzer with solid-state ion-conductive polymer membrane separator 135 that conducts hydroxides through membrane 135 when hydrated. In the AEM configuration, alkaline electrolyte 137 is an optional component that may comprise between 0 and 3M, and up to about 10M salt (e.g., KOH). Matrix 135 (with electrolyte) and/or separator 135 (optionally with electrolyte) are configured to provide ion conductivity between electrodes 130, 140, prevent mixing of the product gases (oxygen and hydrogen), and electrically isolate two electrodes 130, 140 from each other. It is noted that in any of the embodiments, matrix 135 or separator 135 are flooded by low-salinity water 110 and optionally with electrolyte 137, and that in any of the embodiments, matrix 135 or separator 135 are ion-conductive (even if electrolyte 137 is not present) and electrically insulating. It is noted that alkaline electrolyte 137, when used, may comprise any of hydroxides, carbonates or bicarbonates of lithium, sodium, potassium, cesium, or any other soluble alkaline salts able to generate a pH of at least 10 in unsaturated aqueous solution.

Diffusion layer(s) 150 may be configured to reject anions (150A) such as Cl⁻ (especially from entering electrode assembly 120) and OH⁻ (especially from leaving electrode assembly 120). Clearly, diffusion layer(s) 150 are configured to be water permeable, letting water 115 through into electrode assembly 120, and also to allow hydrogen escape from electrode assembly 120, as indicated schematically in FIGS. 1A and 1B.

It is noted that in alkaline electrolyzers 100, cations may be allowed to mix with electrolyte 137, as long as the alkalinity of electrolyte 137 is maintained. For example, inclusion of Na⁺ and/or K⁺ from salt water 106 may not be detrimental to the operation of alkaline electrolyzers 100.

In other embodiments, such as AEM electrolyzers 100, diffusion layer(s) 150 may further be configured to reject cations (150B) of received saline water 106 such as Na⁺ and K⁺. In various embodiments, diffusion layer(s) 150 may comprise at least one anion-rejecting layer 150A and at least one cation-rejecting layer 150B. One or more layers 150A and one or more layers 150B may be arranged in various ways and orders with respect to each other, and some or all of layers 150A, 150B may be integrated to form a single layer or to form a few layers.

In certain embodiments, electrode assembly 120 may be configured as PEM (proton exchange membrane) electrolyzer to comprise a cation exchange membrane 135 (passing protons from anode 140 to cathode 130) and diffusion layer(s) 150 may be configured to reject anions (150A) such as Cl⁻ and OH⁻ and optionally cations (150B) of received saline water 106 such as Na⁺ and K⁺. In various embodiments, diffusion layer(s) 150 may comprise at least one anion-rejecting layer 150A and optionally at least one cation-rejecting layer 150B.

In various embodiments, in addition to materials that provide electrical conductivity (such as various carbons, metals and metal alloys based on, for example, nickel, iron, titanium, gold, platinum, etc.), and gas transport functionality provided by cross-layer pore networks in one or more of the materials, or between one or more of the materials used in the layer, anion-rejecting layer(s) 150A may include any of poly (aryl sulfones), sulfonated polytetrafluoroethylene (PTFE), e.g., perfluorinated polysulfonic acids such as Nafion™, polymers or copolymers of styrene sulfonic acid with various modifications, sulfonated polyimides, phosphoric acid-doped poly (benzimidazole), sulfonated poly(arylene ethers) such as sulfonated poly (ether ether ketone) (SPEEK), crosslinked poly(styrene sulfonate), poly(acrylic acid), etc., and/or other synthetic or natural cation exchange ionomers or polyanions, or any anionic polymers/polyelectrolytes that are inherently insoluble, or made insoluble by immobilization by chemical or physical crosslinking, blending, branching/hyperbranching, etc., and combinations thereof. Cation-rejecting layer(s) 150B may comprise anion conducting ionomer, e.g., polymers or copolymers of (vinylbenzyl)trimethylammonium, copolymers of diallyldimethylammonium (e.g., DADMAC—diallyldimethylammonium chloride), styrene-based polymers having quaternary ammonium anion conducting group, quaternized poly (vinylalcohol) (QPVA), bi-phenyl or tri-phenyl backboned polymers with one or more functional groups that could include alkyl tether group(s) and/or alkyl halide group(s) and/or equivalent groups, poly (arylpiperidinium) and other polymers containing cyclic quaternary ammonium in the backbone or on tethered sidechains, poly (bis-arylimidazoliums), cation-functionalized poly (norbornenes), neutral polymers with grafted anion-conductive sidechains, and/or other synthetic or natural anion exchange ionomers or polycations, or any cationic polymers/polyelectrolytes that are inherently insoluble, or made insoluble by immobilization by chemical or physical crosslinking, blending, branching/hyperbranching, etc., or combinations thereof.

It is noted that any of diffusion layers 150 that is made of poly-ionic materials may be configured to utilize the Donnan effect to reject the respective ions while maintaining sufficient osmotic pressure gradient to move water into electrode assembly 120.

FIGS. 1C and 1D are high-level schematic illustrations of diffusion layer(s) 150, according to some embodiments of the invention. In certain embodiments, diffusion layer(s) may comprise at least one gas transporting phase 150C and at least one water transporting phase 150D, wherein both phases 150C, 150D reject at least the cations (150A). At least one of phases 150C and 150D is electrically conductive. Gas transporting phase(s) 150C and water transporting phase(s) 150D are illustrated in FIG. 1C in a schematic conceptual manner as ordered phases and in FIG. 1D as more intermixed phases, each comprising multiple subunits which provide the phases in combination. The actual structure of phases 150C, 150D may vary, as long as they provide their disclosed functions. Phases 150C, 150D may not necessarily comprise ordered phases and may differ in their extent (e.g., with respect to mass and/or volume), and in the dimensions of their subunits. For example, electrically conductive phase(s) 150C may comprise conductive porous hydrophobic material that allows transport of gases and electrons yet prevents transport of water; and water transporting phase(s) 150D may comprise water-conductive material (e.g., by various mechanisms, such as surface hydrophilicity, water sorption or by any other mechanism) with at least cation exchange functionality to inhibit anion exchange.

For example, electrically conductive phase 150C may comprise hydrophobized porous media while water transporting phase 150D may comprise poly-ionic materials(s).

For example, electrically conductive phase(s) 150C may comprise any of (i) carbon fibers infused with Teflon or with other perfluorinated material, (ii) a microporous layer comprising carbon, metal or other conductive material, with pore sizes that are small enough to generate capillary pressure against liquid water penetration and/or (iii) additives or structures to yield hydrophobicity of phase 150C.

For example, water transporting phase(s) 150D may comprise a cation exchange material with a stationary anionic functional group(s) that resist the passage of anions, e.g., by using the Donnan effect, and/or an anion exchange material with stationary cationic functional group(s) that resist the passage of cations by the Donnan effect. Examples for cation exchange materials for water transporting phase(s) 150D include any of poly (aryl sulfones), sulfonated polytetrafluoroethylene (PTFE), e.g., perfluorinated polysulfonic acids such as Nafion™, polymers or copolymers of styrene sulfonic acid with various modifications, sulfonated polyimides, phosphoric acid-doped poly (benzimidazole), sulfonated poly (arylene ethers) such as sulfonated poly (ether ether ketone) (SPEEK), crosslinked poly (styrene sulfonate), poly (acrylic acid), etc., and/or other synthetic or natural cation exchange ionomers or polyanions, or any anionic polymers/polyelectrolytes that are inherently insoluble, or made insoluble by immobilization by chemical or physical crosslinking, blending, branching/hyperbranching, etc., and combinations thereof. Examples for anion exchange material include anion conducting ionomer, e.g., polymers or copolymers of (vinylbenzyl)trimethylammonium, copolymers of diallyldimethylammonium (e.g., DADMAC-diallyldimethylammonium chloride), styrene-based polymers having quaternary ammonium anion conducting group, quaternized poly (vinylalcohol) (QPVA), bi-phenyl or tri-phenyl backboned polymers with one or more functional groups that could include alkyl tether group(s) and/or alkyl halide group(s) and/or equivalent groups, poly (arylpiperidinium) and other polymers containing cyclic quaternary ammonium in the backbone or on tethered sidechains, poly (bis-arylimidazoliums), cation-functionalized poly (norbornenes), neutral polymers with grafted anion-conductive sidechains, and/or other synthetic or natural anion exchange ionomers or polycations, or any cationic polymers/polyelectrolytes that are inherently insoluble, or made insoluble by immobilization by chemical or physical crosslinking, blending, branching/hyperbranching, etc., or combinations thereof.

It is noted that phases 150C, 150D may be ordered or not ordered, and may be configured to take different volume fractions of diffusion layer(s) 150. Any of at least one anion-rejecting layer 150A and, if present, at least one cation-rejecting layer 150B may be configured to comprise at least one electrically conductive phase 150C and at least one water transporting phase 150D as disclosed herein, possibly with different compositions and/or different structures for different layers 150A, 150B (e.g., additional porous material(s)).

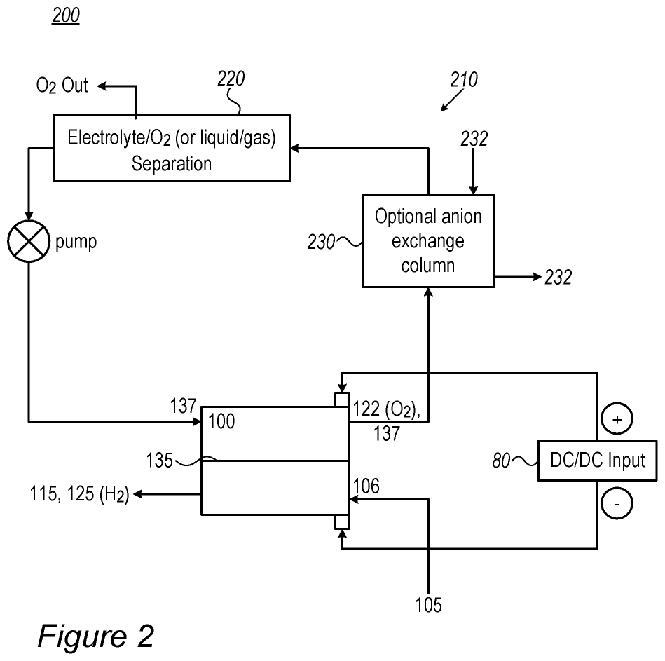

FIG. 2 is a high-level schematic illustration of a water electrolyzer system 200, according to some embodiments of the invention. Water electrolyzer system 200 may comprise water electrolyzer 100 such as alkaline or AEM water electrolyzer 100, a power source 80 connected to and operating water electrolyzer 100, and an electrolyte circulation unit 210 configured to remove oxygen from and recycle electrolyte 137, e.g., using an anion exchange column 230 (e.g., using an anion exchange replenishment solution 232) and an electrolyte/oxygen separation module 220, with a pump returning recycled electrolyte (e.g., KOH) to water electrolyzer 100. Electrolyte circulation unit 210 may be used continuously, batch-wise, or upon requirement to re-establish specified conditions in water electrolyzer 100, e.g., specifies pH level and/or concentration levels of various anions (e.g., removing residual Cl⁻) or cations (e.g., regulating the level of K⁺). It is noted that electrolyte circulation unit 210 may be used to regulate either electrolyte 137 in alkaline water electrolyzer 100 or the wetting liquid surrounding separator 135 in AEM water electrolyzer 100. Anion exchange column 230 may comprise inlet and outlet ports for regenerating anion exchange column 230 with OH⁻ (for alkaline electrolyzers or AEM electrolyzers 100); or with carbonate, bicarbonate or other counterion(s) for PEM electrolyzers 100.

In certain embodiments, water electrolyzer system 200 may be further modified or adjusted to handle PEM water electrolyzers 100, for example by using deionized water or acidic electrolyte in electrolyte circulation unit 210 (the acidic electrolyte may be solid in PEM, and/or the acidic electrolyte may be aqueous). Anion exchange column 230 may be used in electrolyte circulation unit 210 of PEM water electrolyzers 100 to extract any chloride ions or other anions that may enter electrolyzers 100, and may be implemented by an optional deionization unit. Electrolyte/oxygen separation module 220 may be modified to, or implemented as liquid/gas separation module 220.

Anion exchange column 230 may be used to retain and/or regenerate the alkalinity of the circulated electrolyte in electrolyzer 100 if needed, for example in the case that the input water 105 is not recirculated. For example, anion exchange column 230 may be used to retain hydroxide ions (OH) within electrolyzer 100.

Exchange columns 230 may optionally further include a cation exchange material to remove any received cations from the recirculating water/electrolyte, or alternatively, an additional cation exchange column could be added with similar configuration for received cation removal or to regenerate the acidity of acidic electrolyte.

Elements from FIGS. 1A-1C and 2 may be combined in any operable combination, and the illustration of certain elements in certain figures and not in others merely serves an explanatory purpose and is non-limiting.

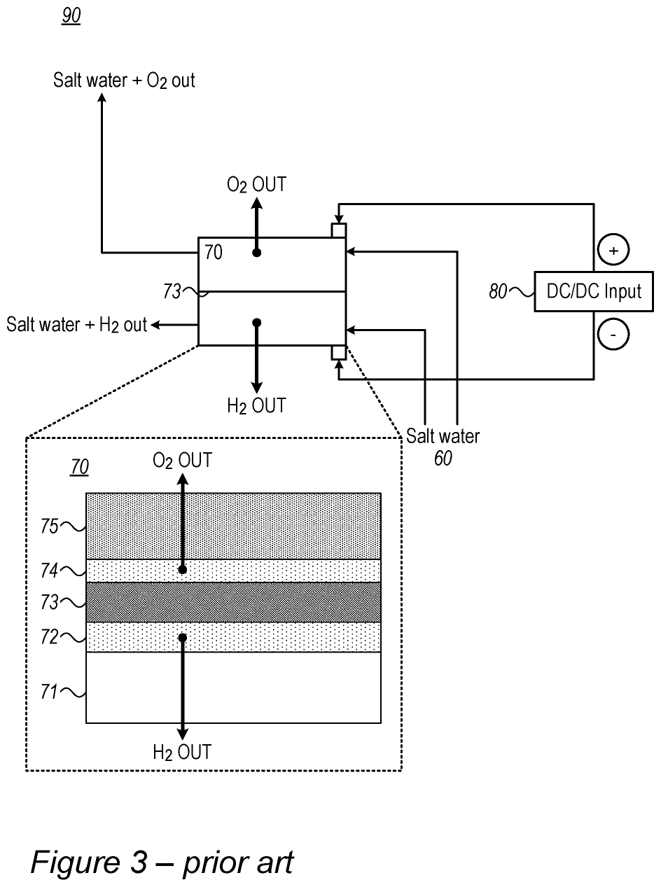

FIG. 3 is a high-level schematic illustration of prior art water electrolyzers 70 and systems 90. FIG. 3 illustrates prior art attempts to operate water electrolyzers (WEs) 70 with an input of salt water 60 (instead of fresh, deionized water)—such as seawater, brine, brackish water, wastewater etc.; that is to say, water which is non-potable and possibly also unsuitable for agriculture or other so-called greywater usage. Such capability would further decrease the amount of resources used to generate the hydrogen leading to a cheaper and lower environmental footprint hydrogen product. Typical water electrolysis systems 90 include DC source 80 and electrolyzer assembly 70 with cathode electrode 72 for generating hydrogen, anode electrode 74 for generating oxygen—the electrodes separated by separator 73 configured to allow H₂O diffusion, provide ion conduction, maintain gas separation, and being electrically insulating. Prior art electrolyzer assemblies 70 further comprise anode diffusion media 75 and cathode diffusion media 71 configured to be electrically conductive, enable gas diffusion and optionally enable water and ion diffusion. Prior art attempts to feed water electrolysis systems 90 with salt water 60 at anode and/or cathode sides, yielding salt water with oxygen and hydrogen, respectively, typically resulted in salt damages to electrolyzers 70, e.g., via interference with the functionality of the electrolyte, accumulation of salt ions such as chloride ions (Cl) (or other halide ions) and sodium ions (Na⁺) and clogging of electrodes. Additional ions that may be present in saline water 60 include potassium ions (K⁺), divalent anions such as carbonate ions (CO₃²⁻), sulfate ions (SO₄²⁻), and phosphate ions (PO₄³⁻), cations such as calcium (Ca²⁺) ions and magnesium ions (Mg²⁺), and generally additional anions and cations.

In various embodiments, disclosed water electrolyzer system 200 and water electrolyzers 100 are configured to prevent salt damage by various means, including configurations of diffusion layer(s) 150. For example, anion-rejecting layer(s) 150A may be configured to reject chloride ions, to prevent their corrosive damage and/or adsorption to the catalysts on electrodes 130, 140 of water electrolyzer 100 (reducing the efficiency and performance of electrolyzer 100), and in case of PEM electrolyzers also their oxidation into toxic chlorine gas (2Cl⁻>Cl₂(g)+2e⁻) due to the similar potential of the OER at neutral and lower pH levels.

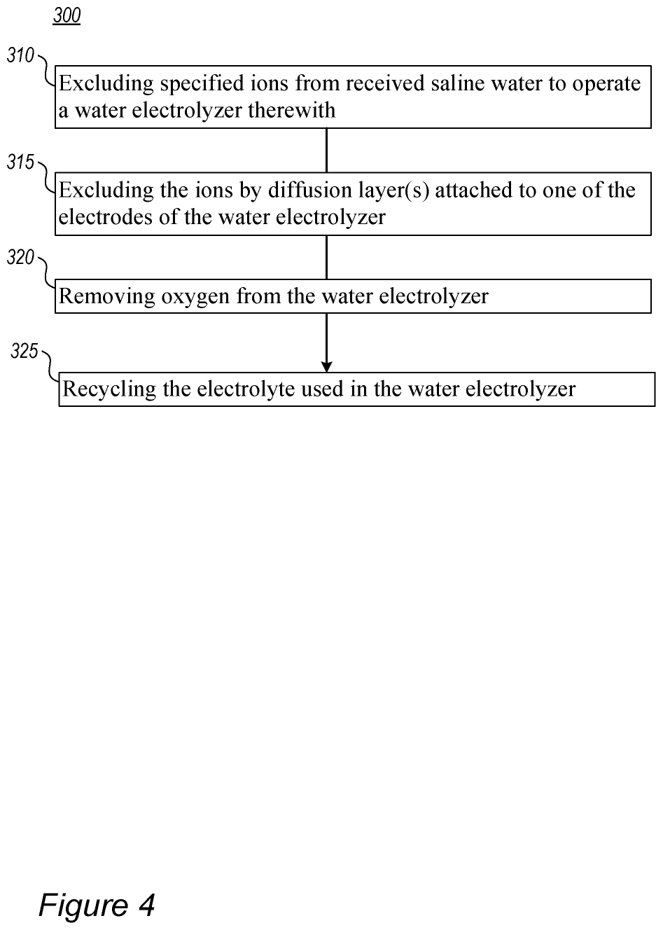

FIG. 4 is a high-level flowchart illustrating a method 300, according to some embodiments of the invention. The method stages may be carried out with respect to water electrolyzer 100 and/or water electrolyzer system 200 described above, which may optionally be configured to implement method 300. Method 300 may comprise the following stages, irrespective of their order.

Method 300 comprises excluding specified ions from received saline water to operate a water electrolyzer therewith (stage 310), wherein the ions are removed by at least one diffusion layer attached to one of the electrodes of the water electrolyzer (stage 315). For example, the water electrolyzer may be an alkaline electrolyzer or an AEM electrolyzer and the rejected ions may be anions and optionally cations; or the water electrolyzer may be a PEM water electrolyzer and the rejected ions may be anions and cations.

Method 300 may further comprise removing oxygen from the water electrolyzer (stage 320) and/or recycling the electrolyte used in the water electrolyzer (stage 325).

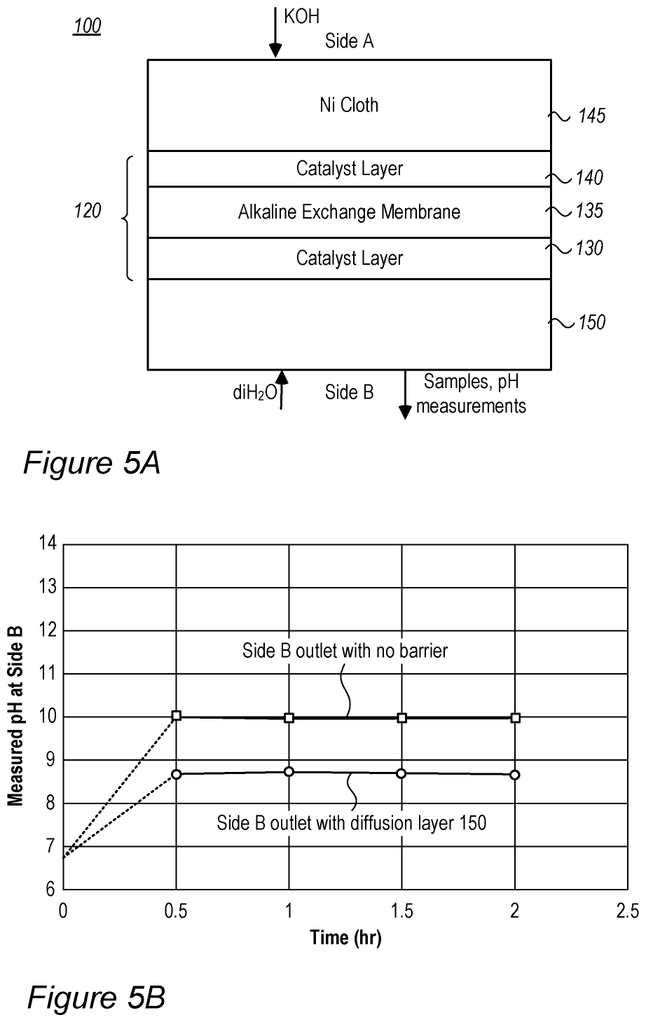

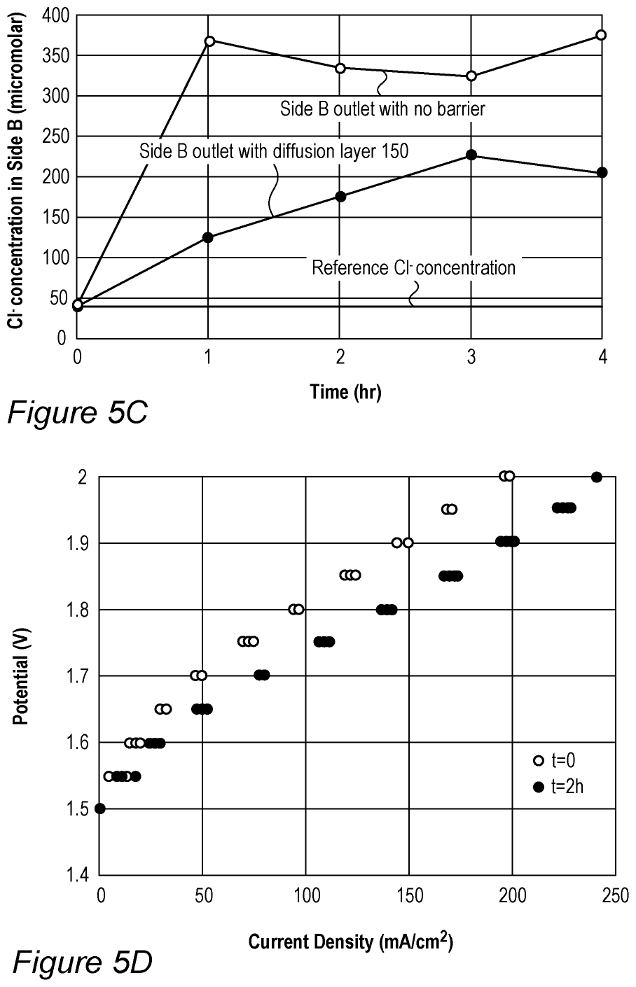

FIGS. 5A-5D present initial experimental results that indicate the effective operation of water electrolyzers 100 with diffusion layer(s) 150, according to some embodiments of the invention. In the illustrated non-limiting example (see FIG. 5A), water electrolyzer 100 comprises AEM (anion exchange membrane) 135 sandwiched between gas-diffusion electrodes to form electrode assembly 120, and set in a stainless-steel electrochemical cell equipped with graphite polar plates with serpentine flow fields to distribute the water flow across the active area of electrode assembly 120. Electrode assembly 120 was sealed in the cell using Teflon™ gaskets adjusted to the thickness of the compressed assembly (diffusion layers+electrodes) on either side of membrane 135. Two additional, 13-micron Kapton sub-gaskets were placed between electrode 130, 140 and membrane 135, and between diffusion media 145, 150 and the respective graphite polar plates, slightly overlapping the layers to prevent passage of water or ions other than through diffusion media 145, 150. The 4 cm² opening of the sub-gaskets was used to define the active area of electrode assembly 120.

Anode 140 and anode diffusion media 145 of electrode assembly 120 were made of a catalyst layer coated on a nickel fiber mat to form the anodic gas diffusion electrode (GDE). Cathode 130 of electrode assembly 120 was made of a catalyst layer coated on a porous, hydrophobized non-woven carbon fiber mat to form the cathodic gas diffusion electrode (GDE). To cause diffusion layer 150 to be an anion-inhibiting layer, the anion inhibiting water-transport phase was made by spray-coating Nafion™ into the same carbon fiber mat from the opposite side (sprayed using nitrogen as carrier of 2.5% ethanol-diluted Nafion™) with a final loading of 5 mg/cm². Resulting diffusion layer 150 therefore has (i) electrically conductive phase 150C (see FIGS. 1C, 1D) comprising the remaining porous areas of the carbon fiber mat (those areas not infused with Nafion™), which are hydrophobized and thereby limit liquid water (and aqueous ion) transport via the pore structure, while facilitating gas transport and retaining electronic conductivity; and (ii) infused cation exchange water transport phase 150D comprising the Nafion™-infused areas serving as an anion transport-resistant but water-permeable phase, as Nafion™ is an anionic polymer with cationic counterions (initially H⁺), which therefore absorbs and transfers water, while the negatively charged anionic functional groups limit the transfer of OH⁻, Cl⁻ and other anions by the Donnan effect.

FIG. 5B indicates the effectiveness of diffusion layer 150 as an inhibiter of anion exchange, according to some embodiments of the invention. The layered structure of water electrolyzer 100 described above was checked, in non-operative state, by feeding KOH (1M, pH>13.5, rate of 500 mL/h) via anode diffusion medium 145 (“Side A”) while deionized water (diH₂O, pH ca. 7/[OH-] ca. 10⁻⁷M) was fed to the other side of the layered structure (“Side B”) without and with the presence of diffusion layer 150—measuring OH⁻ penetration through the layered structure by pH measurements of samples from Side B (without and with diffusion layer 150). OH⁻ penetration was calculated by multiplying the OH⁻ concentration at side B (in mol/L) with respect to the diH₂O flow rate (in L/h) and active area of electrode assembly 120 (4 cm²), as OH⁻ flux equals [OH⁻]·diH₂O flow rate/active area. The results indicate that diffusion layer 150 prevented a reduction of ca. 1.3 pH units (from 10.0±0.03 to 8.7±0.03), effectively reducing OH⁻ flux by a factor of 20 from ca. 13 μmol/cm²/h to much less than 1 μmol/cm²/h.

FIG. 5C indicates the effectiveness of diffusion layer 150 as an inhibitor of anion exchange, according to some embodiments of the invention. The layered structure of water electrolyzer 100 described above was checked, disconnected from any power source, by feeding NaCl (0.5M, rate of 500 mL/h) via anode diffusion medium 145 (“Side A”) while saline water (diH₂O with added Cl⁻ concentration of ca. 45 micromolar) was fed to the other side of the layered structure (“Side B”) without and with the presence of diffusion layer 150—measuring Cl⁻ penetration through the layered structure by titration of samples from Side B (without and with diffusion layer 150). The results show that the rate of Cl⁻ penetration into Side B with diffusion layer 150 as the barrier was about one half of the Cl⁻ penetration without the barrier, with [Cl] in the Side A outlet being reduced from ˜350 micromolar with no barrier to ˜200 micromolar with diffusion layer 150 as barrier, against a 45 micromolar background concentration.

FIG. 5D indicates the effectiveness of diffusion layer 150 in operating water electrolyzer 100, according to some embodiments of the invention. Water electrolyzer 100 described in FIG. 5A was operated with KOH and diH2O flows as described in FIG. 5B. A positive potential bias up to 2.0V was applied to anode 140 at Side A against cathode 130 at Side B, generating electrical current which produced oxygen gas on Side A and hydrogen gas on Side B. FIG. 5D illustrates the current density against different potential values, showing efficient operation and even operation improvements after two hours, possibly resulting from an increase in KOH concentration on the electrode on the cathode side.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A water electrolyzer comprising:
an electrode assembly configured to electrolyze received water to produce oxygen and hydrogen, the electrode assembly comprising two electrodes that are separated by a separator and receive electrical input to carry out the electrolysis, and
at least one diffusion layer attached to one of the electrodes and configured to deliver the water for the electrolysis by excluding specified ions from received saline water from a saline water source.

2. The water electrolyzer of claim 1, wherein electrode assembly comprises alkaline electrolyte and the at least one diffusion layer is configured to reject at least anions of the saline water.

3. The water electrolyzer of claim 2, wherein the rejected anions comprise Cl⁻ and OH.

4. The water electrolyzer of claim 3, wherein the at least one diffusion layer is further configured to reject cations of the saline water.

5. The water electrolyzer of claim 4, wherein the rejected cations comprise Na⁺ and K⁺.

6. The water electrolyzer of claim 4 or 5, wherein the at least one diffusion layer comprises at least one anion-rejecting layer and at least one cation-rejecting layer.

7. The water electrolyzer of claim 1, wherein electrode assembly comprises acidic solid or aqueous electrolyte and the at least one diffusion layer is configured to reject cations and anions of the saline water.

8. The water electrolyzer of claim 7, wherein electrode assembly comprises acidic solid electrolyte.

9. The water electrolyzer of claim 7, wherein the rejected anions comprise Cl⁻ and OH⁻ and the rejected cations comprise Na⁺ and K⁺.

10. The water electrolyzer of claim 7, wherein the at least one diffusion layer comprises at least one anion-rejecting layer and at least one cation-rejecting layer.

11. The water electrolyzer of claim 1, wherein the at least one diffusion layer comprises at least one electrically conductive phase and at least one water transporting phase, wherein both phases configured to reject at least anions.

12. A water electrolyzer system comprising:
the water electrolyzer of claim 1,
a power source connected to and operating the water electrolyzer, and
an electrolyte circulation unit configured to remove oxygen from and recycle the electrolyte.

13. The water electrolyzer system of claim 12, further comprising an anion exchange column in the electrolyte circulation unit.

14. The water electrolyzer system of claim 12, wherein the electrolyte comprises aqueous hydroxides, carbonates or bicarbonates of lithium, sodium, potassium, cesium, or any other soluble alkaline salt.

15. A method comprising excluding specified ions from received saline water to operate a water electrolyzer therewith, wherein the ions are removed by at least one diffusion layer attached to one of the electrodes of the water electrolyzer.

16. The method of claim 15, wherein the water electrolyzer is an alkaline electrolyzer and the rejected ions are anions and optionally cations.

17. The method of claim 15, wherein the water electrolyzer is an anion exchange membrane (AEM) water electrolyzer and the rejected ions are anions and optionally cations.

18. The method of claim 15, wherein the water electrolyzer is a proton exchange membrane (PEM) water electrolyzer and the rejected ions are anions and cations.

19. The method of claim 15, further comprising removing oxygen from the water electrolyzer and/or recycling an electrolyte used in the water electrolyzer.
